(19) United States
(12) Patent Application Publication
(10) Pub. No.: US 2009/0121574 A1
(43) Pub. Date: May 14, 2009

(54) DIRECT CURRENT MOTOR

(75) Inventors: Tomohiro AOYAMA, Kosai-shi (JP); Toshio YAMAMOTO, Kosai-shi (JP); Kazumitsu MORIYA, Kosai-shi (JP)

Correspondence Address: CAESAR, RIVISE, BERNSTEIN,;COHEN & POKOTILOW, LTD., 11TH FLOOR, SEVEN PENN CENTER, 1635 MARKET STREET, PHILADELPHIA, PA, 19103-2212, US

(73) Assignee: ASMO CO., LTD., Kosai-shi (JP)

(21) Appl. No.: 12/267,929

(22) Filed: Nov. 10, 2008

(30) Foreign Application Priority Data
Nov. 14, 2007 (JP) 2007-295855

(51) Int. Cl. H02K 3/28

(52) U.S. Cl. 310/195

(57) ABSTRACT

A direct current motor is disclosed. The motor includes a stator, a commutator, an armature core, and brushes. The stator has a yoke and magnetic poles. The magnetic poles are arranged at a predetermined pitch along a circumferential direction of the yoke. The number of the magnetic poles is represented by the expression: 2×P (P is an integer not less than 2). The commutator has segments that are arranged in a circumferential direction of the commutator. The number of the segments is represented by the expression: P×N (N is an odd number not less than 3). The armature core is rotatable integrally with the commutator and includes teeth provided by the number represented by the expression: 2×P×N. A coil is wound around the teeth by distributed winding. Each one of the brushes is pressed against and contacts the segments. Two of the segments that are electrically short-circuited by one of the brushes are connected to each other by at least two coils that are arranged at an interval corresponding to an integral multiple of the pitch (360°/(2×P)) of the magnetic poles.

### BACKGROUND OF THE INVENTION

The present invention relates to a direct current motor having a stator with four or more magnetic poles.

Japanese Laid-Open Patent Publication No. 2006-121833 discloses a direct current motor having a stator including four magnetic poles, a commutator having ten segments, an armature core that is rotatable integrally with the commutator, and a pair of brushes (an anode brush and a cathode brush) that slidably contact the segments. The magnetic poles are fixed to a yoke to be aligned in a circumferential direction of the yoke. The segments are arranged in a circumferential direction of the commutator to be opposed to the magnetic poles. The armature core has ten teeth, and a coil is wound around the teeth by distributed winding.

In the direct current motor, commutation is executed at different timings for the anode brush and the cathode brush. The positions of the teeth (or, the coils) relative to the magnetic poles at one of these timings are different from those at the other timings. As a result, synchronously with the timings of commutation, great excitation force is produced alternately at the positions corresponding to the magnetic poles of one pole and at the positions corresponding to the magnetic poles of the other pole. Accordingly, distribution of the excitation force generated in the stator, or excitation force produced in each one of the magnetic poles (360°/4), becomes different between the magnetic poles of the different poles that are circumferentially adjacent to each other. This causes great strain in the yoke, thus producing great vibration and high noise disadvantageously.

To solve this problem, the number of the teeth and the number of the segments may be each set to a multiple of the number of the magnetic poles (2×P). However, if there are four magnetic poles as in the above-described case and eight teeth and eight segments are provided, the amplitude of pulsation increases even though the number of pulsations decreases. In this case, the vibration and noise aggravates. Alternatively, if twenty teeth and twenty segments are provided in the above-described case, in which the four magnetic poles are arranged, complicated fusing must be performed by an increased number of cycles to provide the increased number of segments. Further, since the interval between each adjacent pair of the segments decreases, the fusing must be carried out in a limited space. This may trigger erroneous short circuits of the coil, thus lowering reliability.

### SUMMARY OF THE INVENTION

Accordingly, it is an objective of the present invention to provide an easy-to-manufacture and highly reliable direct current motor that reduces vibration and noise by ensuring uniform distribution of excitation force in the stator.

To achieve the foregoing objective and in accordance with one aspect of the present invention, a direct current motor including stator, a commutator, an armature core, and brushes is provided. The stator has a yoke and magnetic poles that are arranged at a predetermined pitch along a circumferential direction of the yoke. The number of the magnetic poles is represented by the expression: 2×P (P is an integer not less than 2). The commutator has segments that are arranged along a circumferential direction of the commutator. The number of the segments is represented by the expression: P×N (N is an odd number not less than 3). The armature core is rotatable integrally with the commutator. The armature core has teeth, the number of which is represented by the expression: 2×P×N. A coil is wound around the teeth by distributed winding. The brushes are pressed against and contact the segments. Two of the segments that are electrically short-circuited by one of the brushes are connected to each other by at least two coils that are arranged at an interval corresponding to an integral multiple of the pitch (360°/(2×P)) of the magnetic poles.

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a plan view schematically showing a direct current motor according to one embodiment of the present invention;

FIG. 2 is a connection diagram representing the direct current motor illustrated in FIG. 1 in a flatly developed state;

FIG. 3 is a diagram schematically representing a direct current motor of a modification in a flatly developed state;

FIG. 4 is a diagram schematically representing a direct current motor of another modification in a flatly developed state;

FIG. 5 is a diagram schematically representing a direct current motor of another modification in a flatly developed state;

FIG. 6 is a diagram schematically representing a direct current motor of another modification in a flatly developed state;

FIG. 7 is a diagram schematically representing a direct current motor of another modification in a flatly developed state;

FIG. 8 is a diagram schematically representing a direct current motor of another modification in a flatly developed state;

FIG. 9 is a diagram schematically representing a direct current motor of another modification in a flatly developed state;

FIG. 10 is a diagram schematically representing a direct current motor of another modification in a flatly developed state;

FIG. 11 is a diagram schematically representing a direct current motor of another modification in a flatly developed and vertically divided state; and

FIG. 12 is a diagram schematically representing a direct current motor of another modification in a flatly developed and vertically divided state.

### DETAILED DESCRIPTION OF THE PREFERRED EMBODIMENTS

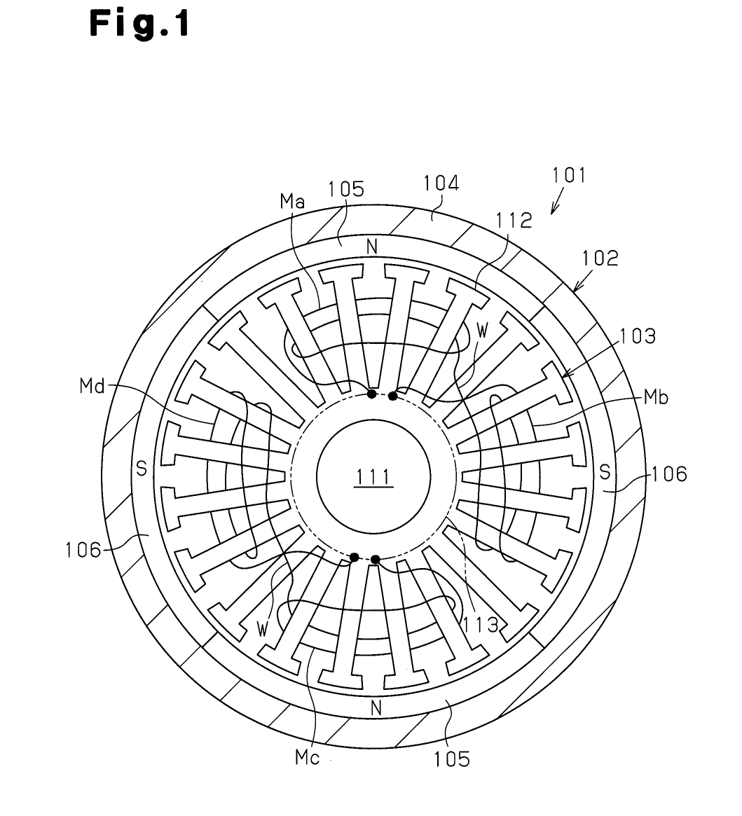

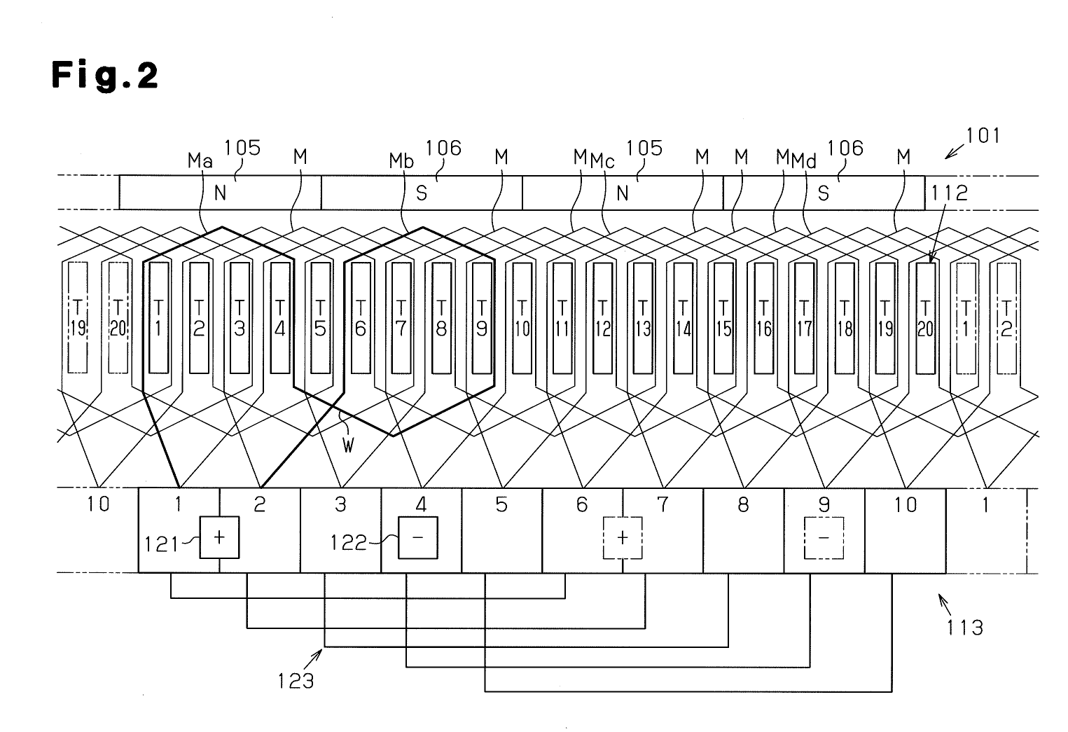

One embodiment of the present invention will now be described with reference to FIGS. 1 and 2.

As illustrated in FIG. 1, a direct current motor 101 of the present embodiment has a stator 102 and an armature (a rotor) 103. The stator 102 has a yoke housing 104, which is a substantially cylindrical yoke, and magnets 105, 106, the number of which is represented by 2P (P is an integer not less than two). The magnets 105, 106 are fixed to the inner circumferential surface of the yoke housing 104 and arranged at equal angular intervals. In the present embodiment, P is 2, and a total of four magnets including two N pole magnets 105 and two S pole magnets 106 are arranged at intervals of 90° in such a manner that the N pole magnets 105 and the S pole magnets 106 are arranged alternately in the circumferential direction. In other words, a total of four magnetic poles are arranged at 90° in the circumferential direction in such a manner that the different magnetic poles are provided alternately in the circumferential direction.

With reference to FIGS. 1 and 2, the armature 103 includes a rotary shaft 111, an armature core 112 fixed to the rotary shaft 111, and a commutator 113 fixed to the rotary shaft 111. The rotary shaft 111 is rotatably supported by the stator 102. In this state, the armature core 112 is arranged to face the magnets 105, 106 in radial directions of the yoke housing 104. That is, the armature core 112 is surrounded by the magnets 105, 106. As illustrated in FIG. 2, an anode brush 121 and a cathode brush 122 are pressed against the outer circumference of the commutator 113 in a slidable manner.

The armature core 112 has a plurality of teeth T1 to T20, which extend radially about the rotary shaft 111. Coils M are wound around the teeth T1 to T20 with non-illustrated insulators in between.

The commutator 113, which is substantially cylindrical, includes segments 1 to 10, the number of which is represented by P×N (N is an odd number not less than 3). The segments 1 to 10 are circumferentially arranged on the outer circumferential surface of a non-illustrated insulating material. In the present embodiment, the commutator 113 has ten segments 1 to 10 (P=2, N=5). The segments 1 to 10, as a whole, form a substantially cylindrical shape on the outer circumference of the insulating material. The anode and cathode brushes 121, 122 are pressed from radially outside to contact the radially outer surfaces of the segments 1 to 10. The commutator 113 includes a short circuit member 123 fixed to an axial end surface of each one of the segments 1 to 10. The short circuit member 123 electrically connects, or short-circuits, each pair of the segments (for example, the segment 1 and the segment 6) that are arranged at a circumferential interval corresponding to the circumferential pitch (360°/P=180°) of the magnetic poles of one pole (which are, for example, the two N pole magnets 105). Short circuiting by the short circuit member 123 brings about a state equivalent to the state in which the anode and cathode brushes 121, 122 are provided. FIG. 2 schematically illustrate such a state achieved by the short circuit member 123 by showing imaginary brushes with the double-dotted chain lines. Further, as illustrated in FIG. 2, the anode brush 121 is arranged at the position corresponding to the circumferential center of one of the N pole magnets 105. The cathode brush 122 is located at the position corresponding to the circumferential center of one of the S pole magnets 106 and spaced from the anode brush 121 by 90° in the circumferential direction.

The number Tx of the teeth T1 to T20 is represented by the expression: Tx=2×P×N. In the present embodiment, P is 2 and N is 5. The number Tx of the teeth T1 to T20 is thus 20.

With reference to FIG. 2, two circumferentially adjacent segments that are electrically short-circuited by the anode brush 121 (or the cathode brush 122) are connected to each other by two coils M that are arranged at an interval corresponding to an integral multiple of the pitch (360°/(2×P)) of the magnetic poles (the magnets 105, 106). For example, in FIG. 2, the anode brush 121 short-circuits the two adjacent segments 1, 2. In the present embodiment, since P is 2, the pitch of the magnetic poles is 90°. Two coils Ma, Mb, which are spaced at an interval corresponding to the equal of a multiple of 90°, or 90°, connect the segments 1, 2, which are short-circuited by the anode brush 121. Also, in the present embodiment, each one of the coils M is wound around four of the teeth by distributed winding. For example, in FIG. 2, the coil Ma (the coil Mb) is wound around the four teeth T1 to T4 (the four teeth T6 to T9) by distributed winding.

As has been described, the two coils Ma, Mb interconnect the two segments (in the example of FIG. 2, the segment 1 and the segment 2) that are electrically short-circuited by the anode brush 121 (or the cathode brush 122), and are arranged circumferentially adjacent to each other. If the interval between the coils Ma, Mb is an odd multiple of the magnetic pole pitch, the winding direction of one of the coils, or the coil Ma, is opposite to the winding direction of the other, or the coil Mb. If the interval between the coils Ma, Mb is an even multiple of the magnetic pole pitch, the coils Ma, Mb are wound in a common winding direction. In the present embodiment, since the interval between the coils Ma, Mb is an odd multiple (the equal) of the magnetic pole pitch, the winding directions of the coils Ma, Mb are opposite to each other. Further, in the embodiment, the coils Ma, Mb are connected in series between the two segments. Specifically, a connecting wire W connects the coil Ma and the coil MB in series. The connecting wire W is arranged at a position facing the commutator 113.

Specifically, for example, a first end of the coil Ma is connected to a riser of the segment 1 (through hooking and fusing). The coil Ma is wound around the teeth T1 to T4 in a first direction, or clockwise as viewed in FIG. 2. A second end of the coil Ma is connected to a first end of the coil Mb through the connecting wire W. The coil Mb is wound around the teeth T6 to T9 in a second direction, or counterclockwise as viewed in FIG. 2. A second end of the coil Mb is connected to a riser of the segment 2 (through hooking and fusing). Like the coils Ma, Mb, the other coils M are arranged between the corresponding pairs of the segments 1 to 10, which are, for example, the segments 2, 3 or the segments 3, 4, in similar manners. In this manner, the coils M are provided uniformly for the teeth T1 to T20. In FIG. 1, only the coils Ma, Mb and the coils Mc, Md, among the coils M, are schematically illustrated. The short circuit member 123 (see FIG. 2) equalizes the potentials of the coils Mc, Md to the potentials of the coils Ma, Mb (an intermediate commutation state). The coils Mc, Md are each arranged at the position corresponding to the circumferential center of the corresponding one of the magnetic poles. In FIG. 2, only the coils Ma, Mb of the coils M are represented by the bold lines for illustrative purposes. Further, in the present embodiment, the number of winding is equal for all of the coils M.

The present embodiment has the following advantages.

(1) The number Tx of the teeth is represented by the expression: Tx=2×P×N. That is, the number Tx is 20. The two segments that are electrically short-circuited by the anode brush 121 (or the cathode brush 122) are connected to each other by two coils M that are spaced at the interval corresponding to an integral multiple of the magnetic pole pitch (360°/(2×P)). In this manner, the positions of the teeth T1 to T20 and the positions of the coils M relative to the corresponding magnetic poles (the conduction states of the teeth T1 to T20 and the conduction states of the coils M with respect to the corresponding magnetic poles) become uniform. As a result, distribution of excitation force produced in the stator 102 becomes uniform. In other words, uniform magnetic force is generated in each one of the magnetic poles (360°/(2×P)). This reduces strain of the yoke housing 104, which is caused by different excitation forces produced in the different magnetic poles that are circumferentially adjacent to each other. Vibration and noise are also suppressed.

Further, unlike the direct current motor disclosed in Japanese Laid-Open Patent Publication No. 2006-121833, in which the number Tx of the teeth and the number of the segments are both multiples of the number of the magnetic poles (2×P), the number Tx of the teeth T1 to T 20 is double the number of the segments 1 to 10 (P×N=10) in the present invention. This increases the number of pulsation and decreases the amplitude of pulsation. Further, the number of the segments 1 to 10 is minimized so as to ensure space for carrying out fusing, decrease the number of fusing cycles, and suppress erroneous short circuiting. This provides an easy-to-manufacture and highly reliable direct current motor that decreases vibration and noise.

(2) The two coils Ma, Mb, which are provided between the two segments that are electrically short-circuited by the anode brush 121 (the cathode brush 122), are spaced at the interval corresponding to the odd multiple (the equal) of the magnetic pole pitch (360°/(2×P)=90°). The winding direction of one of the coils, or the coil Ma, is opposite to the winding direction of the other, or the coil Mb. This causes a desired electric current to flow in each one of the coils M, thus generating a desired magnetic flux and thus a desired torque.

(3) The short circuit member 123 short-circuits two segments, which are, for example, the segment 1 and the segment 6, at the pitch (360°/P=180°) of the magnetic poles of a common pole (for example, the magnets 105 of the N pole). This equalizes the conduction states of the coils M (Ma, Mc) with respect to the two magnetic poles of the common pole (for example, the two N pole magnets 105) and absorbs a difference in induced voltage among the coils M, which is caused by displacement of the magnetic poles. As a result, unintended vibration caused by an error or sparks between the brushes 121, 122 and the segments 1 to 10 are suppressed. Further, the number of the brushes 121, 122 becomes less than (2×P). Specifically, in the present embodiment, since there are two brushes 121, 122, the number of the brushes 121, 122 is les than (2×P=4). This reduces the number of the components of the motor and simplifies the configuration of the motor.

(4) The two coils Ma, Mb interconnecting the two segments that are electrically short-circuited by the anode brush 121 (the cathode brush 122) are connected in series. In this manner, as compared to a case in which the coils Ma, Mb are connected in parallel, the number of connections to the segments 1 to 10, or, specifically, the number of hooking cycles to risers, is decreased. The direct current motor thus becomes easy to manufacture.

The present embodiment may be modified as follows.

In the present embodiment, the two coils Ma, Mb are connected in series between the corresponding two segments. However, the arrangement of the two coils Ma, Mb is not restricted to this. That is, the coils Ma, Mb may be connected in parallel.

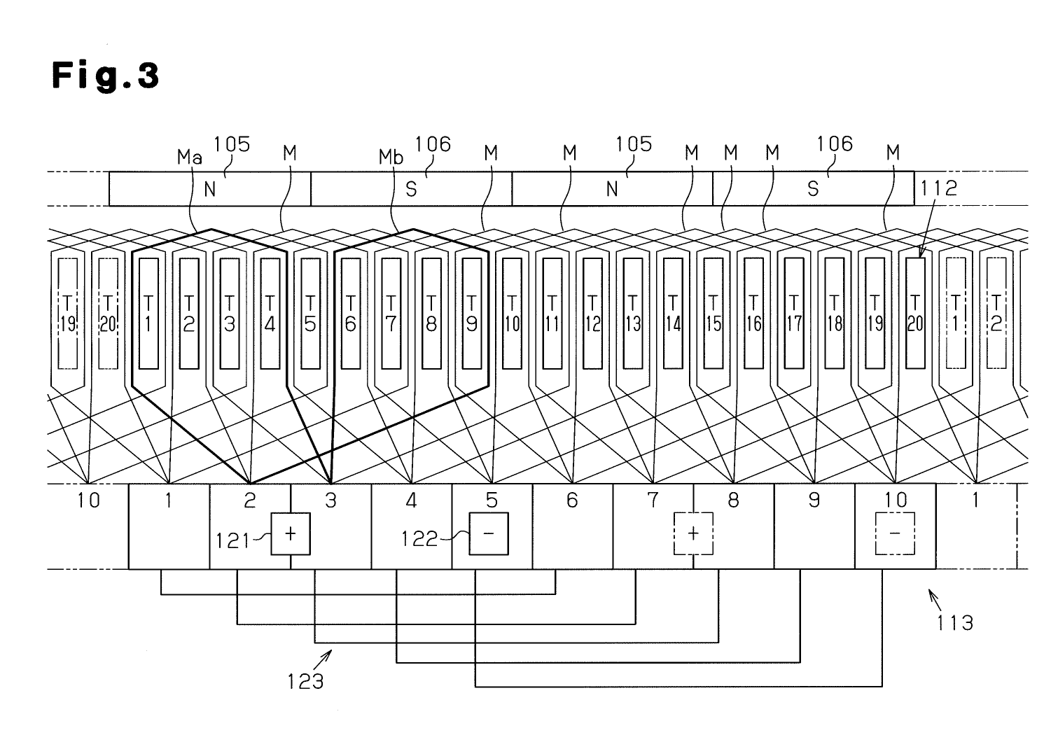

For example, the coils M may be connected as illustrated in FIG. 3. With reference to the illustration, the first end of the coil Ma is connected to a riser of the segment 2 (through hooking and fusing) and the second end of the coil Ma is connected to a riser of the segment 3 (through hooking and fusing). The coil Ma is wound around the teeth T1 to T4 in a first direction, or clockwise as viewed in FIG. 3, by distributed winding. The first end of the coil Mb is connected to a riser of the segment 2 (through hooking and fusing) and the second end of the coil Mb is connected to a riser of the segment 3 (through hooking and fusing). The coil Mb is wound around the teeth T6 to T9 in a second direction, or counterclockwise as viewed in FIG. 3, by distributed winding. Like the coils Ma, Mb, the other ones of the coils M are provided between the corresponding pairs of the segments 1 to 10, which are, for example, the segments 3, 4 or the segments 5, 6, in similar manners. The coils M are thus arranged uniformly for the teeth T1 to T20.

In the direct current motor illustrated in FIG. 3, the anode brush 121 electrically short-circuits the segments 2, 3 with the circumferential center of the corresponding N pole magnet 105 coinciding with the circumferential center of the coil Ma. The cathode brush 122 is spaced from the anode brush 121 by 90°. In FIG. 3, only the coils Ma, Mb of the coils M are represented by bold lines for illustrative purposes.

This modification ensures the advantages equivalent to the advantages (1) to (3) of the above described embodiment.

In the above described embodiment, the two coils Ma, Mb that are arranged at the interval corresponding to the equal of the magnetic pole pitch (360°/(2×P)), which is 90°, are provided between the two segments that are electrically short-circuited by the anode brush 121 (the cathode brush 122). However, the interval between the coils Ma, Mb may be changed as long as the interval corresponds to an integral multiple of the magnetic pole pitch.

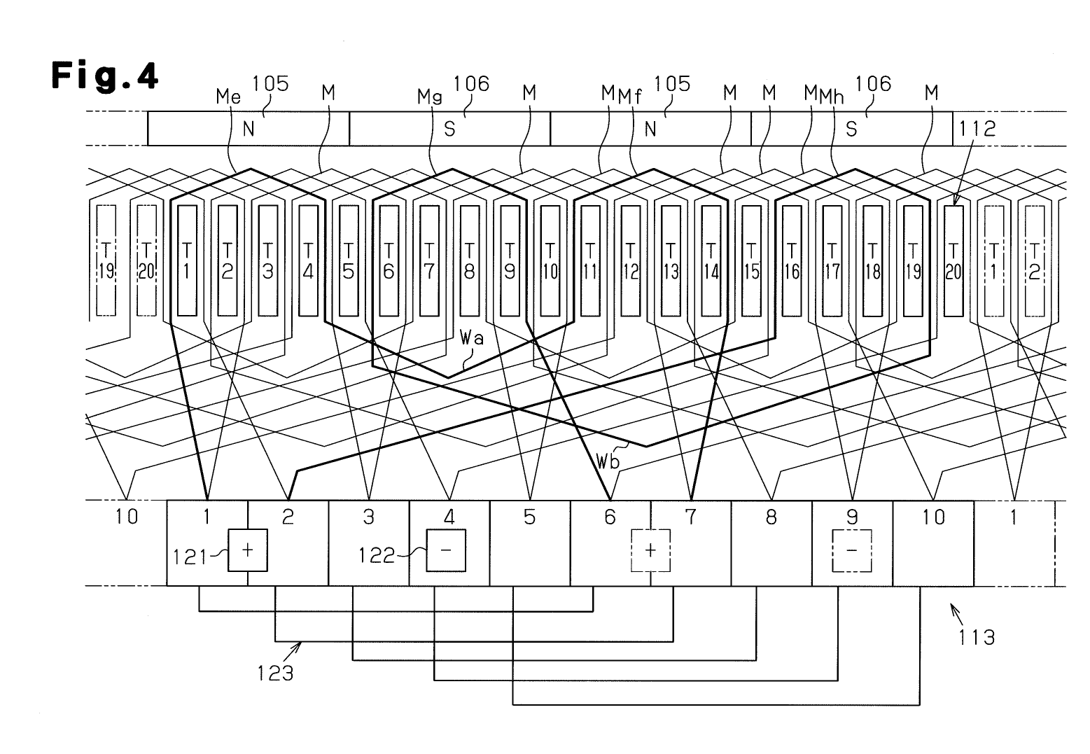

The direct current motor 101 may be modified, for example, as illustrated in FIG. 4. In the direct current motor illustrated in FIG. 4, the interval between the coils is an even multiple of (double) the magnetic pole pitch (360°/(2×P)). In this case, the coils Me, Mf or the coils Mg, Mh are wound in a common winding direction. For example, the first end of the coil Me is connected to a riser of the segment 1 (through hooking and fusing). The coil Me is wound around the teeth T1 to T4 in a first direction, or clockwise as viewed in FIG. 4. The second end of the coil Me is connected continuously to a first end of the coil Mf through a connecting wire Wa. The coil Mf is wound around the teeth T11 to T14 in the first direction, or clockwise as viewed in FIG. 4, by distributed winding. A second end of the coil Mf is connected to a riser of the segment 7 (through hooking and fusing).

For example, a first end of the coil Mg is connected to a riser of the segment 6 (through hooking and fusing). The coil Mg is wound around the teeth T6 to T9 in a second direction, or counterclockwise as viewed in FIG. 4. A second end of the coil Mg is connected continuously to a first end of the coil Mh through a connecting wire Wb. The coil Mh is wound around the teeth T16 to T19 in the second direction, or counterclockwise as viewed in FIG. 4. A second end of the coil Mh is connected to a riser of the segment 2 (through hooking and fusing). Like the coils Me to Mh, the other ones of the coils M are provided between the corresponding pairs of the segments 1 to 10, which are, for example, the segments 3, 9 and the segments 8, 4, in similar manners. The coils M are thus arranged uniformly for the teeth T1 to T20.

In FIG. 4, only the coils Me to Mh of the coils M are represented by the bold lines for illustrative purposes. The configuration illustrated in FIG. 4 also ensures the advantages equivalent to the advantages of the above described embodiment.

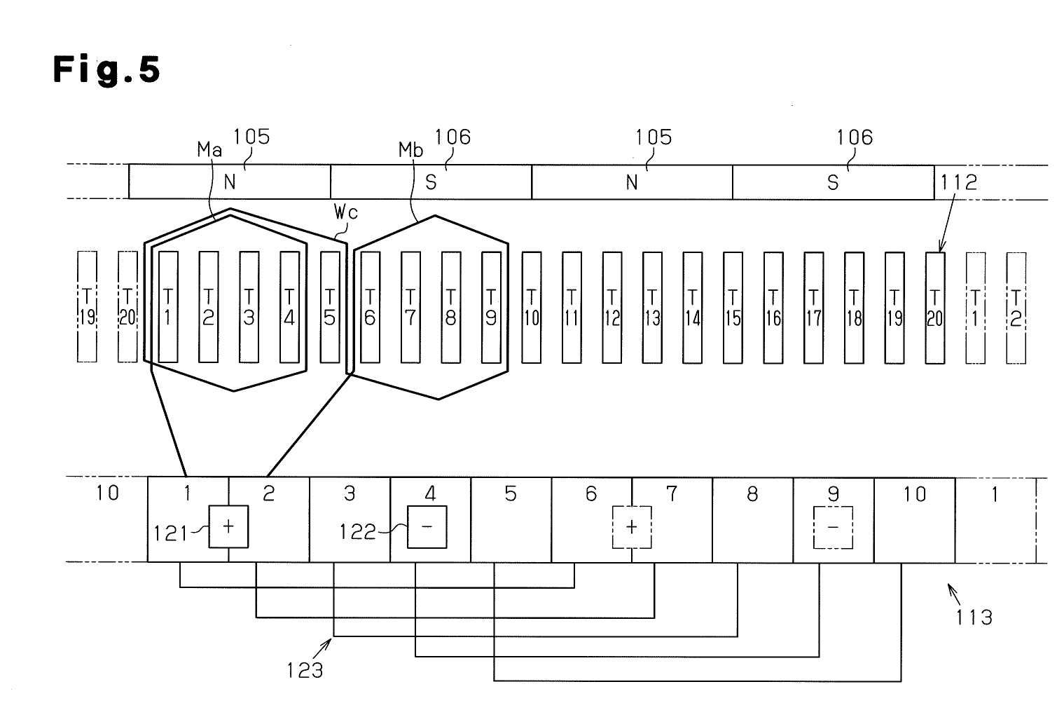

In the above described embodiment, the connecting wire W, which connects the two coils Ma, Mb in series, is arranged at the side opposed to the commutator 113 in the armature core 112. However, the arrangement of the connecting wire W is not restricted to this. Specifically, as illustrated in FIG. 5, a connecting wire Wc may be arranged at the side opposed to the magnetic poles in the armature core 112 (not the side opposed to the commutator 113). In FIG. 5, like the above-described embodiment, only the coils Ma, Mb that are wound around the teeth T1 to T4, T6 to T9 are represented by the bold lines. The other ones of the coils M are not illustrated since the coils M are arranged in the similar manners.

In this manner, the connecting wire Wc, which connects the two coils Ma, Mb to each other, is arranged at a position different from the ends of the coils connected to the segments. This makes it unnecessary to ensure a great interval between the armature core 112 and the commutator 113. Further, the number of winding of the coil M becomes a number represented by (an integer+0.5). As a result, the present invention becomes applicable to a larger variety of direct current motors (a larger range of motor characteristics) including, for example, a motor in which a connecting wire W is located at a side opposed to a commutator 113 in an armature core 112, and a motor in which the number of winding of a coil M is an integer.

In the above described embodiment, the short circuit member 123 is fixed to an axial end surface of each one of the segments 1 to 10. However, the arrangement of the short circuit member 123 is not restricted to this but may be any suitable manner.

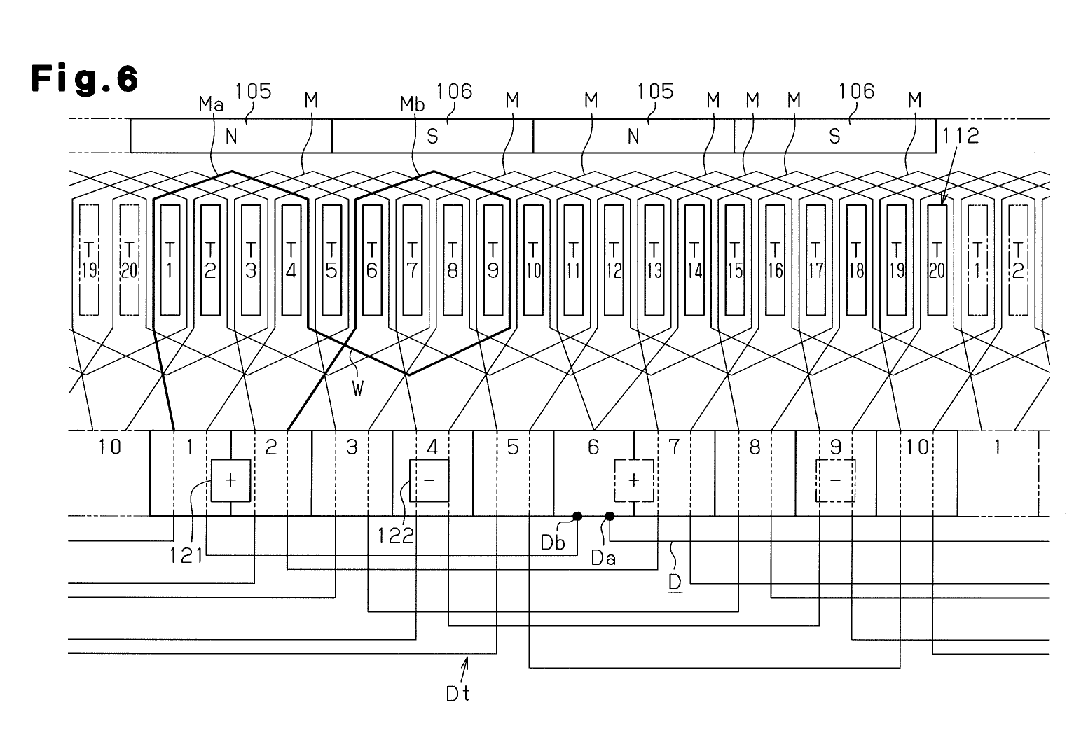

For example, as illustrated in FIG. 6, a single continuous conductive wire D may configure all the coils M of the above described embodiment and short-circuit lines Dt each electrically connecting (short-circuiting) corresponding ones (for example, the segments 1, 6) of the segments 1 to 10.

Specifically, the conductive wire D is connected to a riser of the segment 6 at a first end Da of the conductive wire D (through hooking and fusing). The conductive wire D is then connected to a riser of the segment 1, which is spaced from the segment 6 by 180° (through hooking and fusing). Subsequently, the conductive wire D forms the two coils Ma, Mb and is connected to a riser of the segment 2 (through hooking and fusing). The conductive wire D is then connected to a riser of the segment 7, which is spaced from the segment 2 by 180°, (through hooking and fusing), and configures the corresponding two of the coils M. The conductive wire D is continuously connected by repeating this manner of winding until the conductive wire D reaches the segment 6. After reaching the segment 6, the conductive wire D forms the corresponding two of the coils M. The conductive wire D is then connected to a riser of the segment 7 (through hooking and fusing). Subsequently, the conductive wire D is connected to a riser of the segment 2, which is spaced from the segment 7 180°, (through hooking and fusing) and then configures the corresponding two of the coils M. The conductive wire D is continuously connected by repeating this manner of winding until the conductive wire D reaches the segment 6 again. Eventually, a second end Db of the conductive wire D is connected to a riser of the segment 6 (through hooking and fusing). In the example illustrated in FIG. 6, each pair of the segments 1 to 10 that are spaced from each other by 180° are short-circuited by two short-circuit lines Dt.

This configuration also ensures the advantages equivalent to the advantages of the above described embodiment. Further, since the short-circuit lines Dt, which are provided continuously from the coils M, short-circuit the corresponding ones of the segments 1 to 10, a separate short circuit member (the short circuit member 123) that short-circuits the segments 1 to 10 becomes unnecessary.

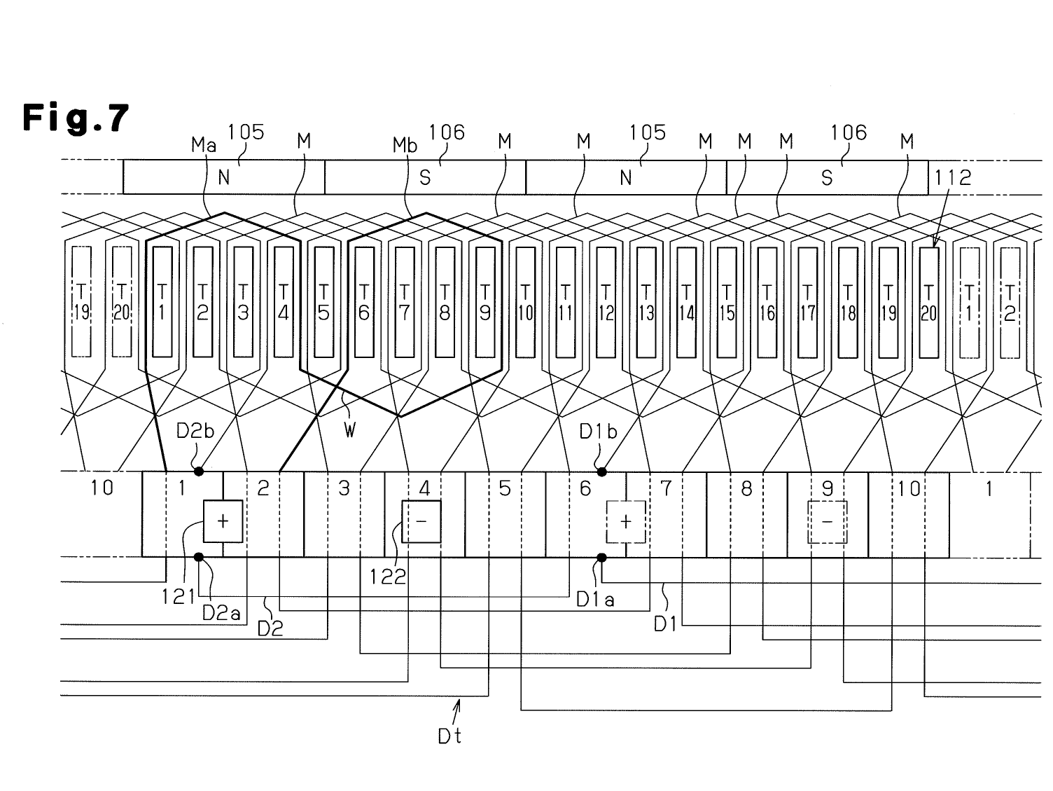

Alternatively, for example, as illustrated in FIG. 7, two conductive wires D1, D2 may configure all of the coils M of the above described embodiment and conductive lines Dt that electrically connect (short-circuit) corresponding ones of the segments 1 to 10 (which are, for example, the segment 1 and the segment 6) to each other. In other words, in the example illustrated in FIG. 7, the configuration similar to the example illustrated in FIG. 6 is formed by the two conductive wires D1, D2 that are connected in similar manners simultaneously at positions spaced from each other by 180°, or double flyers.

Specifically, the conductive wire D1 is connected to a riser of the segment 6 at a first end D1a of the conductive wire D1 (through hooking and fusing) and then to a riser of the segment 1, which is spaced from the segment 6 by 180° (through hooking and fusing). The conductive wire D1 then forms the two coils Ma, Mb and is connected to a riser of the segment 2 (through hooking and fusing). Subsequently, the conductive wire D1 is connected to a riser of the segment 7, which is spaced from the segment 2 by 180°, (through hooking and fusing) and then forms other two of the coils M. The conductive wire D1 is continuously connected by repeating this process of winding until the conductive wire D1 reaches the segment 6. Eventually, a second end D1b of the conductive wire D1 is connected to a riser of the segment 6 (through hooking and fusing).

In the example illustrated in FIG. 7, simultaneously with the conductive wire D1, which is wound and connected in the above-described manner, the conductive wire D2 is connected to a riser of the segment 1 at a first end D2a of the conductive wire D2 (through hooking and fusing) and then to a riser of the segment 6, which is spaced from the segment 1 by 180°, (through hooking and fusing). The conductive wire D2 then forms the corresponding two of the coil M and is connected to a riser of the segment 7 (through hooking and fusing). Subsequently, the conductive wire D2 is connected to a riser of the segment 2, which is spaced from the segment 7 by 180°, (through hooking and fusing) and then forms other two of the coils M. The conductive wire D2 is continuously connected by repeating this process of winding until the conductive wire D2 reaches the segment 1. Eventually, a second end D2b of the conductive wire D2 is connected to a riser of the segment 1 (through hooking and fusing). Also in this example, each pair of the segments 1 to 10 that are spaced from each other by 180° are short-circuited by two short-circuit lines Dt.

This configuration also ensures the advantages equivalent to the advantages of the above described embodiment. Further, since the short-circuit lines Dt, which extend continuously from the coils M, short-circuit the corresponding ones of the segments 1 to 10, a separate member (the short circuit member 123) that short-circuits corresponding ones of the segments 1 to 10 becomes unnecessary. Also, as compared to the example of FIG. 6, the use of the double flyer winding machine reduces the time needed for wiring.

In the above described embodiment, two coils M, which are spaced at the interval corresponding to an integral multiple of the magnetic pole pitch (360°/(2×P)), are provided between two of the segments 1 to 10 hat are electrically short-circuited by the anode brush 121 (or the cathode brush 122). However, three or more coils may be provided between these segments.

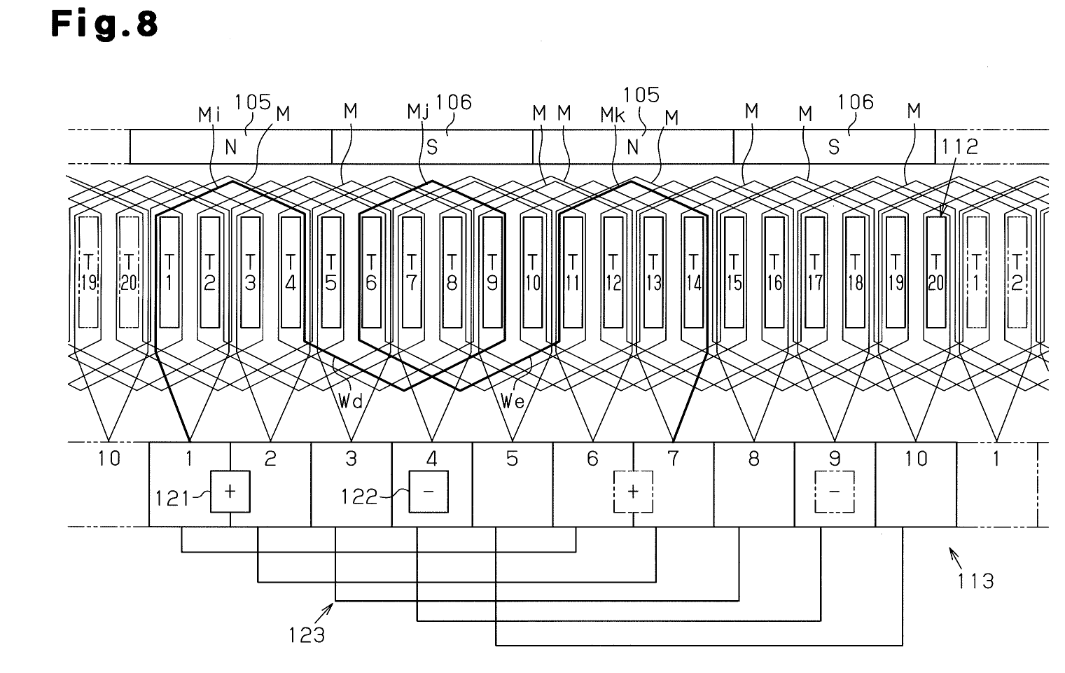

For example, in the example illustrated in FIG. 8, three coils M, which are spaced at an interval corresponding to an integral multiple of the magnetic pole pitch (360°/(2×P)), are provided between two segments that are electrically short-circuited by the anode brush 121 (or the cathode brush 122). Specifically, in the state illustrated in FIG. 8, three coils Mi, Mj, Mk, which are arranged at an interval corresponding to an integral multiple, or the equal, of the magnetic pole pitch (360°(2×P)=90°), or 90°, are provided between two segments 1, 7, which are electrically short-circuited by the anode brush 121.

Specifically, for example, a first end of the coil Mi is connected to a riser of the segment 1 (through hooking and fusing) and the coil Mi is wound around the teeth T1 to T4 in a first direction, or clockwise as viewed in FIG. 8. A second end of the coil Mi is connected to a first end of the coil Mj through a connecting wire Wd. The coil Mj, extending continuously from the connecting wire Wd, is wound around the teeth T6 to T9 in a second direction, or counterclockwise as viewed in FIG. 8. A second end of the coil Mj is connected to the coil Mk through a connecting wire We. The coil Mk is wound around the teeth T11 to T14 in the first direction, or clockwise as viewed in FIG. 8. A second end of the coil Mk is connected to a riser of the segment 7 (through hooking and fusing). Like the coils Mi, Mj, Mk, the other ones of the coils M are provided between the corresponding pairs of the segments 1 to 10, which are, for example, the segments 2, 8 and the segments 3, 9, in similar manners. The coils M are thus arranged uniformly for the teeth T1 to T20. In FIG. 8, only the coils Mi, Mj, Mk of the coils M are represented by the bold lines for illustrative purposes. Also, in the example illustrated in FIG. 8, each one the coils M is wound by distributed winding in the first direction, or clockwise as viewed in FIG. 8. For example, each one of the coils Mi, Mk is overlapped with the corresponding one of the coils M of a different winding path that is commonly wound around the teeth T1 to T4 or the teeth T11 to T14 by distributed winding. As a result, the number of winding of each coil Mi, Mk is set to ½ of the number of winding of the coil Mj and the number of winding of the coils M that are commonly wound around the corresponding teeth T1 to T20 becomes constant as a whole. Also in this configuration, the advantages equivalent to the advantages of the above described embodiment are obtained.

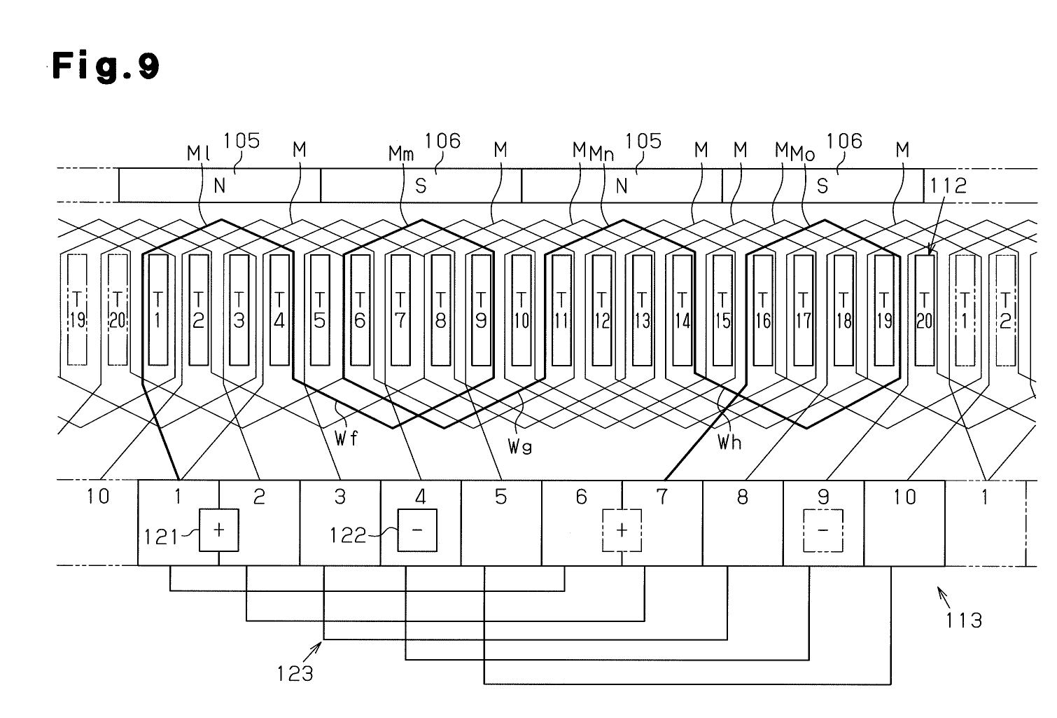

Alternatively, for example, as illustrated in FIG. 9, four coils Ml, Mm, Mn, Mo, which are arranged at an interval corresponding to an integral multiple of the pitch (360°/(2×P)) of the magnetic poles (the magnets 105, 106), are provided between two of the segments 1 to 10 that are electrically short-circuited by the anode brush 121 (or the cathode brush 122). Specifically, in the state illustrated in FIG. 9, the four coils Ml, Mm, Mn, Mo, which are arranged at an interval corresponding to an integral multiple, or the equal, of the pitch (360°(2×P)=90°) of the magnetic poles (the magnets 105, 106), or 90°, are provided between two segments 1, 7 that are electrically short-circuited by the anode brush 121.

Specifically, for example, a first end of the coil Ml is connected to a riser of the segment 1 (through hooking and fusing) and the coil Ml is wound around the teeth T1 to T4 in a first direction, or clockwise as viewed in FIG. 9. A second end of the coil Ml is connected to a first end of the coil Mm through a connecting wire Wf. The coil Mm, extending continuously from the connecting wire Wf, is wound around the teeth T6 to T9 in a second direction, or counterclockwise as viewed in FIG. 9. A second end of the coil Mm is connected to the coil Mn through a connecting wire Wg. The coil Mn is wound around the teeth T11 to T14 in the first direction, or clockwise as viewed in FIG. 9. A second end of the coil Mn is connected to the coil Mo through a connecting wire Wh. The coil Mo is wound around the teeth T16 to T19 in the second direction, or counterclockwise as viewed in FIG. 9. A second end of the coil Mo is connected to a riser of the segment 7 (through hooking and fusing). Like the coils Ml, Mm, Mn, Mo, the other ones of the coils M are provided between the corresponding pairs of the segments 1 to 10, which are, for example, the segments 2, 8, the segments 3, 9, the segments 4, 10, and the segments 5, 1 in similar manners. The coils M are thus arranged uniformly for the teeth T1 to T20. In FIG. 9, only the coils Ml, Mm, Mn, Mo of the coils M are represented by the bold lines for illustrative purposes. Also in this configuration, the advantages equivalent to the advantages of the above described embodiment are obtained.

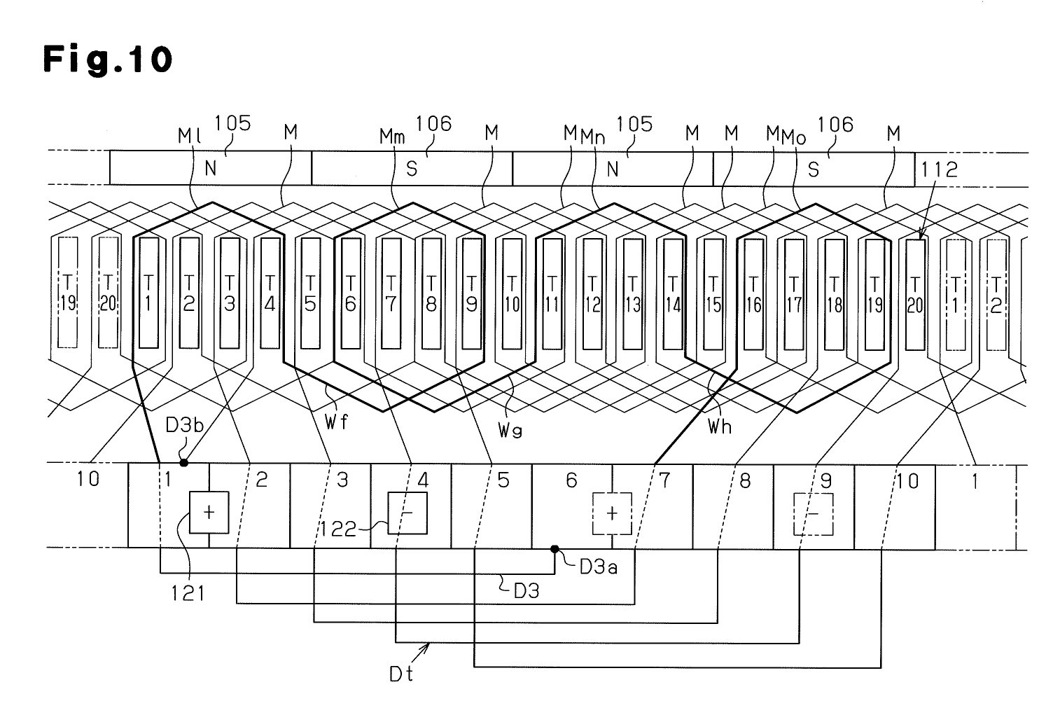

Alternatively, the example illustrated in FIG. 9 may be modified to the form illustrated in FIG. 10, for example. In this example, a single conductive wire D3 configures all of the coils M of the above-described modification (including the coils Ml, Mm, Mn, Mo, see FIG. 9) and short-circuit lines Dt that electrically connect (short-circuit) corresponding ones of the segment 1 to 10 (which are, for example, the segment 1 and the segment 6).

Specifically, in the example of FIG. 10, the conductive wire D3 is connected to a riser of the segment 6 at a first end D3a of the conductive wire D3 (through hooking and fusing) and then to a riser of the segment 1, which is spaced from the segment 6 by 180°, (through hooking and fusing). The conductive wire D3 then forms the coils Ml, Mm, Mn, Mo, which are illustrated in FIG. 9, and is connected to a riser of the segment 7 (through hooking and fusing). Subsequently, the conductive wire D3 is connected to a riser of the segment 2, which is spaced from the segment 7 by 180°, (through hooking and fusing) and then forms other four of the coils M. The conductive wire D3 is continuously connected by repeating this manner of winding until the conductive wire D3 reaches the segment 1. Eventually, a second end D3b of the conductive wire D3 is connected to a riser of the segment 1 (through hooking and fusing).

Also in this case, the advantages equivalent to the advantages of the above described embodiment are obtained. Further, since the short-circuit lines Dt extending continuously from the coils M short-circuit the corresponding ones of the segments 1 to 10, a separate component (the short circuit member 123) that short-circuits the segments 1 to 10 becomes unnecessary.

In the above described embodiment, the present invention is embodied as the direct current motor 101 having the four magnets 105, 106 each serving as a magnetic pole and the ten segments 1 to 10. However, the invention is not restricted to this but may be embodied as any suitable type of direct current motors having a different number of magnets or segments. Even in these cases, the number Tx of the teeth must be a number represented by (2×P×N). Also, as in the embodiment, at least two coils that are arranged at an interval corresponding to an integral multiple of the magnetic pole pitch (360°/(2×P)) must be provided between two segments that are electrically short-circuited by at least one brush.

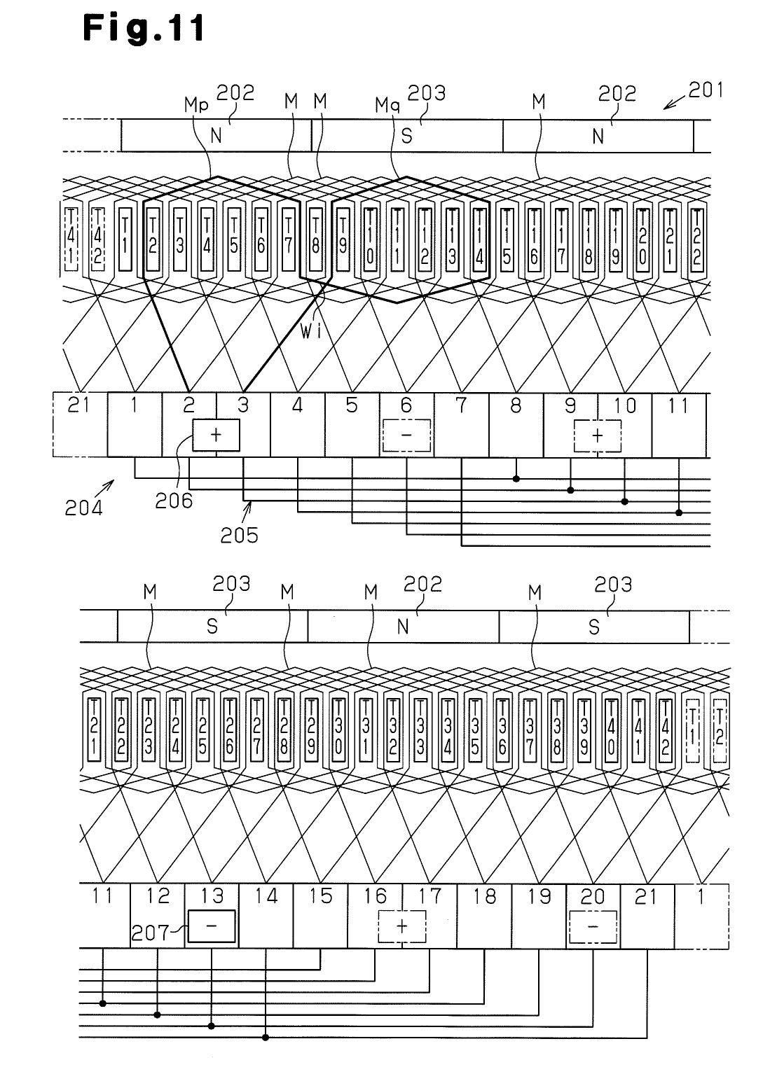

The embodiment may be modified to, for example, a direct current motor 201 illustrated in FIG. 11. The direct current motor 201 has six magnets 202, 203 each serving as a magnetic pole and a commutator 204 having twenty-one segments 1 to 21. The commutator 204 is fixed to an axial end surface of each one of the segments 1 to 21. The commutator 204 includes a short circuit member 205, which electrically connects (short-circuits) corresponding ones of the segments 1 to 21 (which are, for example, the segment 1, the segment 8, and the segment 15) at the pitch (360°/3=120°) of the magnetic poles of a common pole (for example, the N pole magnets 202). An anode brush 206 of the direct current motor 201 is arranged at the position corresponding to the circumferential center of the corresponding N pole magnet 202. A cathode brush 207 of the direct current motor 201 is located at the position corresponding to the circumferential center of the corresponding S pole magnet 106 and spaced from the anode brush 206 by 180°.

The number Tx of the teeth T1 to T42 is represented by the expression Tx=2×P×N (in this example, P=3 and N=7). In the example, the number Tx of the teeth T1 to T42 is thus 42.

Further, two coils M that are spaced at an interval corresponding to an integral multiple of the pitch (360°/(2×P)) of the magnetic poles (the magnets 202, 203) are provided between two (a circumferentially adjacent pair) of the segments 1 to 21 that are electrically short-circuited by the anode brush 206 (or the cathode brush 207). Specifically, in the state illustrated in FIG. 11, two coils Mp, Mq, which are arranged at an interval corresponding to an integral multiple, or the equal, of the pitch (360°(2×P)=60°) of the magnetic poles (the magnets 202, 203), or 60°, are provided between two segments 2, 3, which are electrically short-circuited by the anode brush 206. Also, the coils Mp, Mq of this example are wound around six of the teeth T1 to T42 by distributed winding. For example, the coil Mp is wound around the teeth T2 to T7 by distributed winding. The coil Mq is wound around the teeth T9 to T14 by distributed winding. The two coils M (Mp, Mq) that are provided between two (a circumferentially adjacent pair) of the segments 1 to 21 (the segments 2, 3), which are electrically short-circuited by the anode brush 206 (or the cathode brush 207), are connected in series between these of the segments 1 to 21 (the segment 2 and the segment 3).

Specifically, for example, a first end of the coil Mp is connected to a riser of the segment 2 (through hooking and fusing). The coil Mp is wound around the teeth T2 to T7 in a first direction, or clockwise as viewed in FIG. 11. A second end of the coil Mp is connected to a first end of the coil Mq through a connecting wire Wi. The first end of the coil Mq is wound around the teeth T9 to T14 in a second direction, or counterclockwise as viewed in FIG. 11. A second end of the coil Mq is connected to a riser of the segment 3 (through hooking and fusing). Like the coils Mp, Mq, the other ones of the coils M are arranged between the corresponding pairs of the segments 1 to 21, which are, for example, the segments 3, 4 or the segments 4, 5, in similar manners. In this manner, the coils M are provided uniformly for the teeth T1 to T42. In FIG. 11, only the coils Mp, Mq, among the coils M, are represented by the bold lines for illustrative purposes. Also in this case, the advantages equivalent to the advantages of the above described embodiment are obtained.

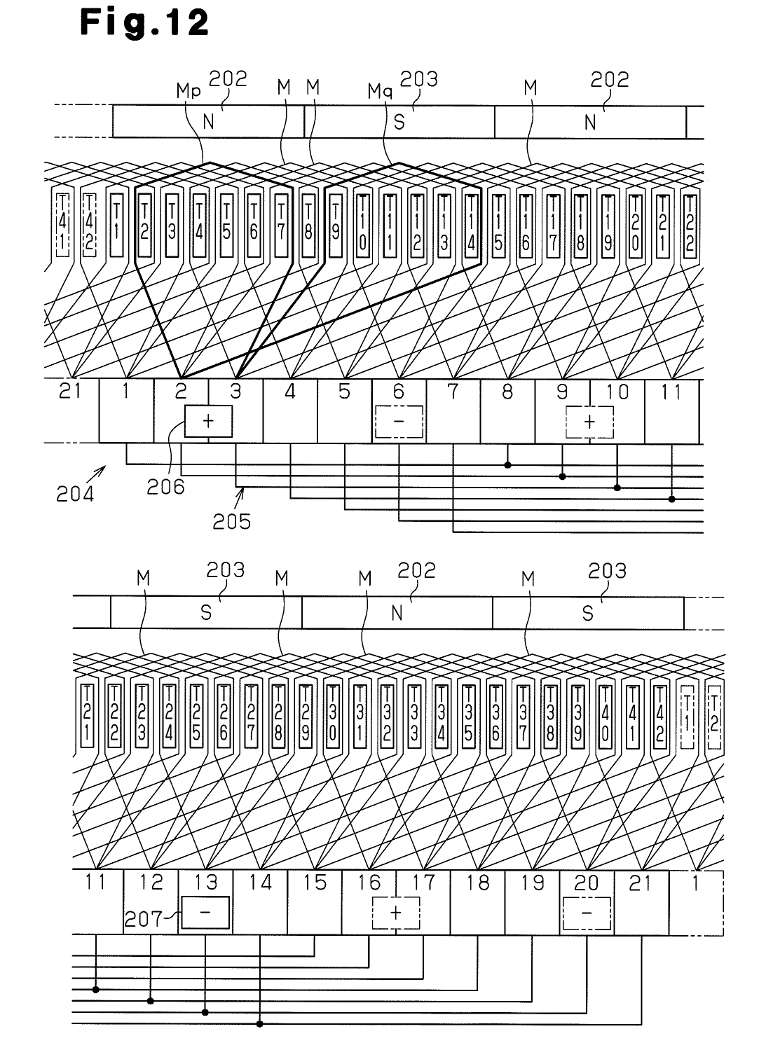

Alternatively, the above-described modification (see FIG. 11) may be modified to the form illustrated in FIG. 12. In the example illustrated in FIG. 12, the two coils Mp, Mq illustrated in FIG. 11 are connected in parallel, like the modification of FIG. 3.

Specifically, for example, a first end of the coil Mp is connected to a riser of the segment 2 (through hooking and fusing). The coil Mp is wound around the teeth T2 to T7 in a first direction, or clockwise as viewed in FIG. 12. A second end of the coil Mp is connected to a riser of the segment 3 (through hooking and fusing). A first end of the coil Mq is connected to a riser of the segment 2 (through hooking and fusing) and wound around the teeth T9 to T14 in a second direction, or counterclockwise as viewed in FIG. 12. A second end of the coil Mq is connected to a riser of the segment 3 (through hooking and fusing). Like the coils Mp, Mq, the other ones of the coils M are arranged between the corresponding pairs of the segments 1 to 21, which are, for example, the segments 3, 4 or the segments 5, 6, in similar manners. In this manner, the coils M are provided uniformly for the teeth T1 to T42. In FIG. 12, only the coils Mp, Mq, among the coils M, are represented by the bold lines for illustrative purposes. Also in this case, the advantages equivalent to the advantages (1) to (3) of the above described embodiment are obtained.

In the above described embodiment and the modifications illustrated in FIGS. 3 to 12 (see FIGS. 3 to 12), each pairs of the segments 1 to 10 (1 to 21) are short-circuited at the pitch (360°/P) of the magnetic poles of a common pole. However, the present invention is not restricted to this. Specifically, additional brushes may be arranged at the positions of the imaginary brushes represented by the double-dotted chain lines in FIGS. 2 to 12, without performing short circuiting. In other words, the number of the brushes may be a number represented by (2×P).

What is claimed is:

1. A direct current motor including:
a stator having a yoke and magnetic poles that are arranged at a predetermined pitch along a circumferential direction of the yoke, the number of the magnetic poles being represented by the expression: 2×(P is an integer not less than 2);
a commutator having segments that are arranged along a circumferential direction of the commutator, the number of the segments being represented by the expression: P×N (N is an odd number not less than 3);
an armature core that is rotatable integrally with the commutator, the armature core having teeth, the number of which is represented by the expression: 2×P×N, a coil being wound around the teeth by distributed winding; and
brushes that are pressed against and contact the segments,
wherein two of the segments that are electrically short-circuited by one of the brushes are connected to each other by at least two coils that are arranged at an interval corresponding to an integral multiple of the pitch (360°/(2×P)) of the magnetic poles.

2. The direct current motor according to claim 1, wherein, if the interval between the at least two coils is an odd multiple of the pitch (360°/(2×P)) of the magnetic poles, the winding direction of one of the coils is opposite to the winding direction of the other one of the coils, and wherein, if the interval between the two coils is an even multiple of the pitch (360°/(2×P)) of the magnetic poles, the coils are wound in a common winding direction.

3. The direct current motor corresponding to claim 1, wherein the segments are short-circuited at the pitch (360°/(2×P)) of the magnetic poles of a common pole.

4. The direct current motor according to claim 3, wherein a conductive wire extending continuously from the coils short-circuits the segments.

5. The direct current motor according to claim 3, wherein the number of the brushes is less than (2×P).

6. The direct current motor according to claim 1, wherein the at least two coils are connected in series between two segments that are electrically short-circuited by one of the brushes.

7. The direct current motor according to claim 6, wherein the at least two coils are connected to each other by a connecting wire, the connecting wire being arranged at a side other than the side opposed to the commutator in the armature core.
